(19) United States
(12) Patent Application Publication
(10) Pub. No.: US 2024/0344372 A1
(43) Pub. Date: Oct. 17, 2024

(54) CLOSURE PANEL SYSTEM WITH MOTOR OUTPUT INTERLOCK CONTROL

(71) Applicant: MAGNA CLOSURES INC., Newmarket (CA)

(72) Inventor: John ZEABARI, Highland, MI (US)

(21) Appl. No.: 18/632,226

(22) Filed: Apr. 10, 2024

Related U.S. Application Data
(60) Provisional application No. 63/459,712, filed on Apr. 17, 2023.

(51) Int. Cl. E05B 81/56; E05B 81/06; E05B 81/14; E05B 81/20; E05B 81/34; E05B 83/24; H02K 7/116; H02P 7/03

(52) U.S. Cl. CPC E05B 81/56; E05B 81/06; E05B 81/20; E05B 83/243; H02K 7/1166; H02P 7/04; E05B 81/14; E05B 81/34

(57) ABSTRACT

An actuator system and method of operation are provided. The system includes at least one actuator including a motor. The system also includes a remote controller configured to generate a command signal to operate the actuator. At least one actuator controller is in communication with the remote controller and the at least one actuator and is configured to receive the command signal from the remote controller to operate the at least one actuator. The at least one actuator controller is configured to generate a motor control signal using the command signal for actuating the motor to operate the actuator and determine the validity of the motor control signal using the command signal. The at least one actuator controller prevents actuation of the motor if the motor control signal is invalid.

### CROSS-REFERENCE TO RELATED APPLICATION

This utility application claims the benefit of U.S. Provisional Application No. 63/459,712 filed Apr. 17, 2023. The entire disclosure of the above application is incorporated herein by reference.

### FIELD

The present disclosure relates to actuation systems for motor vehicles, and more particularly, to actuation systems for motor vehicle closure panels.

### BACKGROUND

This section provides background information related to the present disclosure which is not necessarily prior art.

Latches for vehicle front hoods, whether for front engine hoods or front trunk hoods also known as frunks, are typically actuated in two stages. During a first stage a first release device, such as a handle, is actuated from inside the passenger compartment of the vehicle which moves the latch from a primary closed position to secondary closed position, wherein the latch is partially released, but still retains a striker of the hood to keep the hood from being fully opened. To release the latch completely the vehicle occupant typically must exit the vehicle and actuate a second release device, such as a lever, that is under the hood. This may be inconvenient in some situations.

Double-pull release latches for vehicle hoods are also known, which allows a user to pull twice on the hood release handle located inside the passenger compartment of the vehicle to cause the latch to both transition from the primary closed position to the secondary closed position upon the first pull, and then to fully release the latch from the secondary closed position to a fully open position upon the second pull. Such double-pull release latches can help prevent hazards such as unintended opening of the vehicle hood, which can be particularly problematic if the hood is a front hood that is caused to open while the vehicle is moving.

Latches for vehicle hoods may also be electrically actuated. However, as with double-pull release latches, such electrically actuated latches may need to meet specific safety qualifications or standards. One such scheme is Automotive Safety Integrity Level (ASIL) defined in International Organization for Standardization (ISO) 26262—Functional Safety for Road Vehicles standard. According to the standard, there are four ASILs identified: ASIL A, ASIL B, ASIL C, ASIL D. ASIL A dictates the lowest integrity requirements on the product and ASIL D the highest.

In view of the above, there remains a need to develop alternative actuation systems which address and overcome limitations and drawbacks associated with known actuation systems as well as to provide increased safety and enhanced operational capabilities.

### SUMMARY

This section provides a general summary of the present disclosure and is not a comprehensive disclosure of its full scope or all of its features, aspects and objectives.

It is an aspect of the present disclosure to provide a system including at least one actuator including a motor. The system also includes a remote controller configured to generate a command signal to operate the actuator. At least one actuator controller is in communication with the remote controller and the at least one actuator. The at least one actuator controller is configured to receive the command signal from the remote controller to operate the actuator generate a motor control signal using the command signal for actuating the motor to operate the actuator. The at least one actuator controller is also configured to determine the validity of the motor control signal using the command signal. The at least one actuator controller prevents actuation of the motor if the motor control signal is invalid.

In another aspect, the at least one actuator controller includes a body control module and an actuator control module coupled to the body control module. The actuator control module includes a motor driver circuit coupled to the motor of the actuator for providing electrical power from a main vehicle battery to the motor corresponding to the motor control signal. The actuator control module also includes a memory unit and an actuator communication interface unit for providing communication between the body control module and the actuator control module. In addition, the actuator control module includes an actuator computing unit coupled to the motor driver circuit and the communication interface unit and the memory unit.

In another aspect, the at least one actuator controller includes a safety controller coupled to the actuator communication interface unit to provide communication between the actuator control module and the safety controller.

In another aspect, the safety controller includes a safety battery input coupled to the main vehicle battery, a safety local interconnect network input, and a safety ground input coupled to a main electrical ground. The safety controller includes a safety battery source unit connected to the safety battery input and the safety ground input. The safety controller also includes a safety local interconnect network physical layer unit connected to the safety ground input and the actuator communication interface unit and the safety local interconnect network input for communicating with the remote controller. The body control module includes a body battery input coupled to the main vehicle battery, a body local interconnect network input, and a body ground input coupled to the main electrical ground. The body control module includes an active low output unit connected to the body ground input and to the actuator control module. The body control module includes a body battery source unit connected to the body battery input and the body ground input. The body control module includes a body local interconnect network physical layer unit connected to the body ground input and to the actuator communication interface unit and the body local interconnect network input for communicating with the remote controller. The actuator control module includes an actuator battery filter unit coupled to the main vehicle battery and to the actuator computing unit and to the main electrical ground. The actuator control module includes an active low input filter unit coupled to the active low output unit of the body control module and to the actuator computing unit and to the main electrical ground. The actuator control module includes a sensor input unit for coupling to a plurality of actuator sensors of the actuator and coupled to the main electrical ground. The motor driver circuit includes a plurality of motor switches coupled to the main vehicle battery and the actuator computing unit and the motor of the at least one actuator. The actuator control module includes a sense resistor unit coupled to the main electrical ground and the actuator computing unit. The actuator control module includes a sensor filter unit coupled to the sensor input unit for filtering signals from the plurality of actuator sensors.

In another aspect, the motor of the at least one actuator is a cinch motor of a latch and the plurality of actuator sensors include a first cinch sensor and a second cinch sensor disposed ninety degrees out of phase with one another to provide the actuator control module with signals indicative of the rotated position of a cinch gear. The actuator computing unit is configured to determine a motor direction of the cinch motor by a rising edge sequence of the first cinch sensor and the second cinch sensor and monitor a duty cycle of a sensor period for sensor continuity and robustness.

In another aspect, the safety controller is configured to receive the command signal from the remote controller and output a first enable command and the body control module is configured to receive the command signal from the remote controller and output a second enable command. The actuator control module is configured to receive the first enable command and the second enable command and generate the motor control signal based on the first enable command and the second enable command. The actuator control module is also configured to perform an enable command safety integrity check of the motor control signal with the first enable command and the second enable command using an output interlock circuit. In addition, the actuator control modules is configured to output a validated motor control signal to the motor driver circuit.

In another aspect, the motor driver circuit includes a plurality of motor switches coupled to the main vehicle battery and the actuator computing unit and the motor. The plurality of motor switches includes a first high side switch and a second high side switch and a first low side switch and a second low side switch. The motor driver circuit includes a first motor output coupled to the first high side switch and the second high side switch and to the motor and a second motor output coupled to the first low side switch and the second low side switch and to the motor. The motor driver circuit also includes a first primary control line input coupled to a first primary control output of the actuator computing unit and a second primary control line input coupled to a second primary control output of the actuator computing unit for switching the main vehicle battery to the first motor output and the second motor output based on a first primary control signal and a second primary control signal from the first primary control output and the second primary control output of the actuator computing unit. The motor driver circuit includes a first high side switch input coupled to the first high side switch and a second high side switch input coupled to the second high side switch and a first low side switch input coupled to the first low side switch and a second low side switch input coupled to the second low side switch. The motor driver circuit includes a secondary control line input coupled to a secondary control output of the actuator computing unit for receiving a pulse width modulation signal from the secondary control output of the actuator computing unit.

In another aspect, the memory unit includes an operative condition truth table defining and associating a plurality of input entries corresponding to the first primary control line input and the second primary control line input and the secondary control line input with the first high side switch input and the second high side switch input and the first low side switch input and the second low side switch input. The actuator computing unit is configured to read the operative condition truth table and operate the motor driver circuit accordingly.

In another aspect, the at least one actuator controller includes a safety controller coupled to the actuator computing unit. The safety controller is configured to receive the command signal from the remote controller and output the first enable command. The body control module is configured to receive the command signal from the remote controller and output the second enable command. The system further includes a primary interlock control unit of an output interlock circuit having a first and logic gate configured to logically and the first enable command and the first primary control signal and output a validated first primary control signal to the first primary control line input of the motor driver circuit and a second and logic gate configured to logically and the second enable command and the second primary control signal and output a validated second primary control signal to the second primary control line input of the motor driver circuit.

In another aspect, the system further includes a secondary interlock control unit of the output interlock circuit including a secondary logic and gate configured to logically and the pulse width modulation signal from the secondary control output of the actuator computing unit and the first enable command and the second enable command to output a validated secondary control signal to the secondary control line input of the motor driver circuit.

It is another aspect of the disclosure to provide an actuation system. The actuation system includes at least one actuator including a motor and a remote controller configured to generate a command signal to operate the actuator. At least one local controller is integrated in the at least one actuator and in communication with the remote controller and the at least one actuator. The at least one local controller is configured to receive the command signal from the remote controller to operate the actuator. The at least one local controller determines the state of the actuator and determines a fault of the actuator. The at least one local controller is also configured to generate a motor control signal using at least one of the command signal, the state of the at least one actuator, and the fault of the at least one actuator for actuating the motor to operate the at least one actuator. The at least one local controller additionally transmits at least one of the fault and the state of the at least one actuator to the remote controller.

In another aspect, the at least one actuator further includes a plurality of actuator switches indicative of the state of the at least one actuator and each of the plurality of actuator switches includes a parallel resistor connected in parallel with each of the plurality of actuator switches and a series resistor connected in series with each of the plurality of actuator switches for allowing diagnosis of each of the plurality of actuator switches and wherein the at least one local controller includes at least one fault detector configured to diagnose the plurality of actuator switches.

In another aspect, the plurality of actuator switches includes at least one of a detent switch and an unlatch switch and a cinch switch and an ajar switch.

In another aspect, the actuation system further includes a battery voltage fault detector circuit coupled to a main vehicle battery for detecting a battery voltage of the main vehicle battery. The battery voltage fault detector circuit is coupled to the at least one fault detector to determine whether the battery voltage is out of a predetermined range and generate an interrupt accordingly.

In another aspect, the at least one local controller includes a motor drive circuit having a current level output coupled to the at least one fault detector and the motor driver circuit includes a first motor output coupled to the motor and a second motor output coupled to the motor and each of the first motor output and the second motor output are coupled to the at least one fault detector for sensing voltage and current of the first motor output and the second motor output.

It is yet another aspect of the disclosure to provide a method for controlling an actuator including a motor. The method includes the steps of receiving a command signal from a remote controller to operate the actuator and generating a motor control signal using the command signal for actuating the motor to operate the at least one actuator. The method continues by comparing the motor control signal and the command signal to determine the validity of the motor control signal. The method also includes the step of preventing actuation of the motor if the motor control signal is invalid.

In another aspect, the method further includes the step of defining and associating a plurality of input entries in an operative condition truth table in a memory unit corresponding to a first primary control line input and a second primary control line input and a secondary control line input with a first high side switch input and a second high side switch input and a first low side switch input and a second low side switch input of a motor drive circuit coupled to the motor. The method also includes the step of reading the operative condition truth table and operating the motor driver circuit accordingly.

In another aspect, the method further includes the step of receiving the command signal from the remote controller and outputting the first enable command using a safety controller. Next, receiving the command signal from the remote controller and outputting the second enable command using a body control module. The method continues by receiving the first enable command and the second enable command and generating the motor control signal based on the first enable command and the second enable command using an actuator control module. The method additionally includes the step of performing an enable command safety integrity check of the motor control signal with the first enable command and the second enable command using the latch control module. The method also includes the step of outputting a validated motor control signal to the motor driver circuit.

In another aspect, the method further includes the step of logically anding the first enable command and a first primary control signal from an actuator computing unit and outputting a validated first primary control signal to the first primary control line input of the motor driver circuit using a first and logic gate of a primary interlock control unit. The method also includes the step of logically anding the second enable command and a second primary control signal from the actuator computing unit and outputting a validated second primary control signal to the second primary control line input of the motor driver circuit using a second and logic gate of the primary interlock control unit.

In another aspect, the method further includes the step of logically anding a pulse width modulation signal from the actuator computing unit and the first enable command and the second enable command to output a validated secondary control signal to a secondary control line input of the motor driver circuit using including a secondary logic and gate of a secondary interlock control unit.

It is yet a further aspect of the disclosure to provide a safety critical system for controlling a vehicle component. The system includes a safety controller configured to issue a safety command signal representative of a safety critical decision based on a safety-related function. The system also includes an actuator controller configured to receive the safety command signal and generate a motor actuation command signal using the safety command signal, and further configured to generate a validated motor actuation command signal using the motor actuation command signal and the safety command signal. In addition, the system includes an actuator comprising a motor configured to control the vehicle component in response to receiving the validated motor actuation command signal.

It is an additional aspect of the disclosure to provide an ASIL D compliant latch control module (LCM) having a safety module having a output interlock circuit for receiving a safety signal from a safety controller having a lower than an ASIL D safety compliance level as substantially shown and described.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of a vehicle including an actuation system according to aspects of the disclosure;

FIG. 2 is an isometric view showing components of an actuator of the actuation system of FIG. 1 according to aspects of the disclosure;

FIG. 3 is a more detailed block diagram showing further details of the actuation system of FIGS. 1 and 2 according to aspects of the disclosure;

FIG. 4 shows an actuator control module of the actuation system with an output interlock circuit according to aspects of the disclosure;

FIGS. 5-8 illustrate the actuation system using an operative condition truth table according to aspects of the disclosure;

FIGS. 9-11 illustrate the actuation system employing a partial motor override control according to aspects of the disclosure;

FIGS. 12-14 illustrate the actuation system employing a full motor override control according to aspects of the disclosure;

FIG. 15 illustrates a functional diagram of the actuation system according to aspects of the disclosure;

FIGS. 16 and 17 illustrate a plurality of actuator switches of the actuator indicative of the state of the actuator and at least one fault detector according to aspects of the disclosure;

FIG. 18 shows a battery voltage fault detector circuit of the actuation system according to aspects of the disclosure;

FIG. 19 shows sensing of a voltage and a current of motor outputs of the actuation system according to aspects of the disclosure; and

FIG. 20 illustrates example diagnostics of a plurality of motor switches for open circuit and short circuit detection according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, example embodiments of an actuation system constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

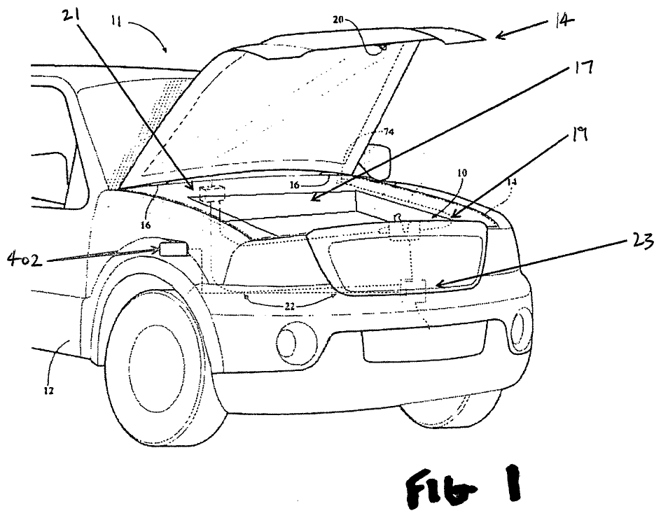

Referring to FIG. 1, in accordance with an illustrative non-limiting embodiment, shown is a vehicle 11 with a vehicle body 12 having one or more closure panels, shown as a front vehicle hood 14 connected to the vehicle body 12 via one or more panel operation components, for example, such as, but not limited to, a hinge 16 and a hood latch assembly, referred to hereafter as latch 10 (e.g. for retaining the closure panel 14 in a closed position once closed or for retaining the closure panel 14 in an open position once opened). The hood 14 selectively closes a front trunk or frunk 17 and has a mating latch component 20 (e.g. striker) fixedly mounted thereon for selective coupling with the latch 10 mounted on the vehicle body 12. The hood 14 can be moved between a fully closed position (shown in phantom outline), a partially opened position (released from fully closed position but retain by latch 10 against being fully opened), and an open panel position (shown in solid outline) in response to selective actuation of latch 10, such as via a communication member 19, e.g. cable and/or electrical member, configured in operable communication with a hood latch release member/mechanism 74 in an internal passenger cabin of the vehicle 11. Also provided is a hood latch system including the latch 10 and an actuation system 22 for automatically sensing, signaling and actuating the intended operation of the latch 10 in response to an imminent impact, such as a front end collision event, e.g. collision with a pedestrian, as further discussed below. In this manner, the hood latch system including the actuation system 22 and latch 10 can communicate to forcefully provide, upon sensing, signaling and deployment, some form of force assisted open operation (e.g. partially open) of the hood 14, thereby reducing the potential for harm to the pedestrian landing on the hood 14.

Movement of the hood 14 (e.g. between the open and closed panel positions) can be electronically and/or manually operated. As such, it is recognized that movement of the hood 14 can be manual or power assisted during operation of the hood 14 at, for example: between fully closed (e.g. fully locked or fully latched) and fully open (e.g. fully unlocked or fully unlatched) positions; and/or between fully closed and partially open (e.g. partially unlocked or partially unlatched) positions; and/or between partially open and fully open positions. It is recognized that the partially open position of the hood 14 can also include a secondary lock/latch member (e.g. hood 14 has a primary lock configuration/position at fully closed and a secondary lock configuration/position at partially open), discussed further below.

Actuation system 22 includes a vehicle controller (e.g. vehicle computer, such as an electronic control unit or a Body Control Module (BCM) 21) coupled to a remote controller or vehicle system 25 configured in electrical communication with a local actuator controller 21, 23, 402 including an actuator or Latch Control Module (LCM) 23 located on the vehicle body 12 and/or on the hood 14 (e.g. at the front of the vehicle 11 such as in the vehicle front bumper) and with latch 10. The actuation system 22 also includes a safety controller 402 that is coupled to the latch control module 23 and to the vehicle system 25.

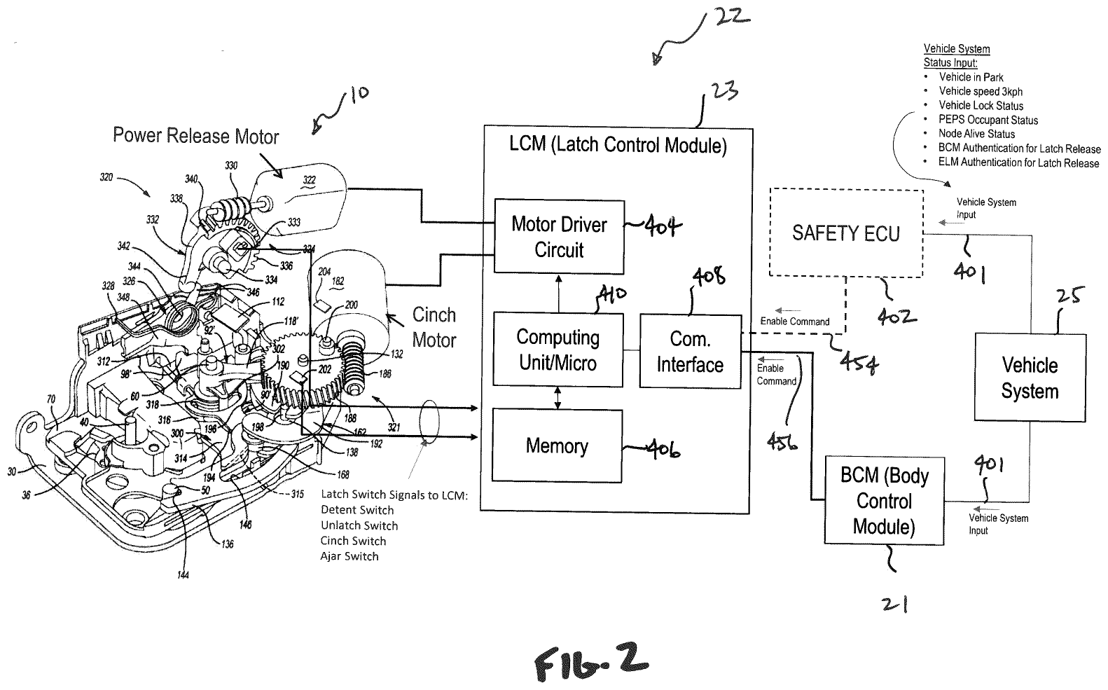

Latch 10 take many forms, for example, such as but not limited to the power latch assembly shown in U.S. Publication No. 2016/0244999, incorporated herein by reference. Latch 10 shown in FIG. 2 includes a frame plate 30 and at least one actuator 320, 321. Specifically, the latch 10 includes a first power-operated actuator arrangement 320 for controlling a power release function and a second power-operated actuator arrangement 321 for controlling a power cinching function. Latch 10 also includes a ratchet 36 and a pawl. The ratchet 36 supported for pivotal movement on a ratchet pivot pin 40 extending outwardly from frame plate 30. A projection, such as an upstanding ratchet lug or rivet 50, extends outwardly from a leg segment of ratchet 36.

The first power-operated actuator arrangement or power-operated release actuator 320 is configured to generally include an electric motor 322, a gearset 324, a pawl release lever 326, and a pawl release lever biasing member 328. Gearset 324 includes a worm 330 driven by the output of electric motor 322 and a power release gear 332 driven by worm 330. Power release gear 332 is supported for rotation about a gear pivot post 334 and includes a geared section 336 and a body section 338. Geared section 336 includes a sector of gear teeth 340 in constant meshed engagement with threads of worm 330. Body section 338 is shown to include an elongated drive arm 342. Pawl release lever 326 is supported from latch housing 70 for rotation about a pivot point 344 and is configured to include a first lug segment 346, a second lug segment 348, and a spring retainer segment 350. Pawl release lever biasing member 328 acts between spring retainer segment 350 and latch housing 70 to normally bias pawl release lever 326 in a first rotary direction (counterclockwise) toward a non-actuated position (shown). As seen, first lug segment 346 on pawl release lever 326 is located in close proximity to drive arm 342 of power release gear 332 while second lug segment 348 is located in close proximity to first bent end segment 98′ of a pawl lever 90′. Pawl lever 90′ is located in its first pawl lever position when pawl release lever 326 is located in its non-actuated position. Likewise, pawl lever 90′ is located in its second pawl lever position when pawl release lever 326 is located in an actuated position. The latch 10 also includes a release lever 92′ including a first drive arm segment 118′ and a second drive arm segment which is configured to extend through a lost motion slot in pawl lever 90′. A plate segment of pawl lever 90′ is configured to include a first bent end segment, a second bent end segment, and an intermediate segment defining an arcuate lost motion slot 302.

Rotation of pawl release lever 326 between its non-actuated position and its actuated position is caused by rotation of power release gear 332 between a “release start” position and a “release stop” position in response to actuator controller 21, 23, 402 receiving a release signal from the vehicle system 25 (e.g., from a power release switch). Electric motor 322 controls the direction of rotation of power release gear 332. Specifically, rotation of power release gear 332 in a releasing direction (e.g., counterclockwise) from its release start position toward its release stop position causes drive arm 342 to engage first lug segment 346 and forcibly rotate pawl release lever 326, in opposition to the biasing of spring 328, from its non-actuated position into its actuated position. Such rotation of pawl release lever 326 causes its second lug segment 348 to engage first bent end segment 98′ of pawl lever 90′ and forcibly pivot pawl lever 90′ about pivot 60 from its first pawl lever position into its second pawl lever position, thereby forcibly pivoting pawl 38 from its ratchet checking position into its ratchet release position.

Movement of inside backup lever 300 from a first inside backup lever position to a second inside backup lever position acts to coordinate movement of a pawl from a ratchet checking position into a ratchet release position with the disengagement of ratchet 36 from an engagement shoulder 144 on cinch link lever 136 for permitting ratchet 36 to move into a striker release position. Inside backup lever 300 is configured to include a first end segment 312, a second end segment 314, and an intermediate segment 316 having a lost motion slot 318 generally aligned with a portion of lost motion slot 302 formed in pawl lever 90′ and into which a second drive arm segment of release lever 92′ extends. Pivotal movement of inside backup lever 300 results in its cam edge surface 315 engaging follower 168 and forcibly moving follower 168 into engagement with an edge surface of a guide slot 146 in cinch link lever 136.

Latch 10 is configured to provide a power cinching operation solely via actuation of power-operated cinching actuator 321 and a soft opening power release operation via coordinated actuation of both power-operated actuators 320 and 321. The power cinching operation is employed to rotate ratchet 36 from either of a low-energy/soft close striker capture position or a high-energy/hard close striker capture position into its fully closed/cinched striker capture position. The ratchet 36 is mechanically held in its cinched striker capture position by cinch mechanism 130. The power cinching operation is again initiated upon detection of pawl being located in its pawl checking position via sensor 112 and actuator controller 21, 23, 402.

The second power-operated actuator arrangement or power-operated cinch actuator 321 includes electric motor 182 that controls rotation of cinch gear 188 between its cinch start and cinch stop positions. Specifically, a worm 186 is driven by a rotary output shaft of electric motor 182, and the cinch gear 188 is in constant meshed engagement with worm 186. Cinch gear 188 includes integral drive flange 190 having drive slot 192, recessed segment 194 and cam segment 196. Drive post 198 on cinch lever 134 is again retained within drive slot 192 to coordinate movement of a cinch mechanism with rotation of cinch gear 188. The cinch mechanism includes a cinch pivot pin 132, a cinch lever, and a cinch link lever 136. A cinch lever pivot pin 138 pivotably interconnects a second segment of cinch lever to a first end segment of cinch link lever 136. The cinch mechanism also includes a J-shaped disengage lever 162. A first end segment of disengage lever 162 is supported for pivotal movement on cinch pivot pin 132. A second end segment of a disengage lever has a follower 168 that is located within and selectively engages edge portions of a follower slot in cinch link lever 136. A position detecting device, such as a magnet 200, is mounted on cinch gear 188 and functions in cooperation with a first cinch sensor 202 and a second cinch sensor 204 to provide actuator controller 21, 23, 402 with signals indicative of the rotated position of gear 188.

Continuing to refer to FIG. 2, the actuators 320, 321 of the latch 10 comprise part of the actuation system 22. As discussed, the system 22 also includes the remote controller (e.g., vehicle system 25) configured to generate a command signal 401 or vehicle system input parameters to operate the actuator 320, 321. The system 22 also includes the at least one actuator controller 21, 23, 402 in communication with the remote controller 25 and the at least one actuator 320, 321. The at least one actuator controller 21, 23, 402 is configured to receive the command signal 401 from the remote controller 25 to operate the actuator 320, 321. The at least one actuator controller 21, 23, 402 is also configured to generate a motor control signal 403 using the command signal 401 for actuating the motor 182, 322 to operate the actuator 320, 321. In addition, the at least one actuator controller 21, 23, 402 determines the validity of the motor control signal 403 using the command signal 401 and prevents actuation of the motor 182, 322 if the motor control signal 403 is invalid.

In more detail, the at least one actuator controller 21, 23, 402 includes the body control module 21 and an actuator or latch control module (LCM) 23 coupled to the body control module 21. The latch control module 23 includes a motor driver circuit 404 coupled to the motor 182, 322 of the actuator 320, 321 for providing electrical power from a main vehicle battery 405 to the motor 182, 322 corresponding to the motor control signal 403. The latch control module 23 also includes a memory unit 406 and an actuator communication interface unit 408 for providing communication between the body control module 21 and the actuator control module 23. The latch control module 23 additionally includes an actuator computing unit 410 coupled to the motor driver circuit 404 and the communication interface unit 408 and the memory unit 406. In addition, the at least one actuator controller 21, 23, 402 includes a safety controller 402 coupled to the actuator communication interface unit 408 to provide communication between the actuator control module 23 and the safety controller 402.

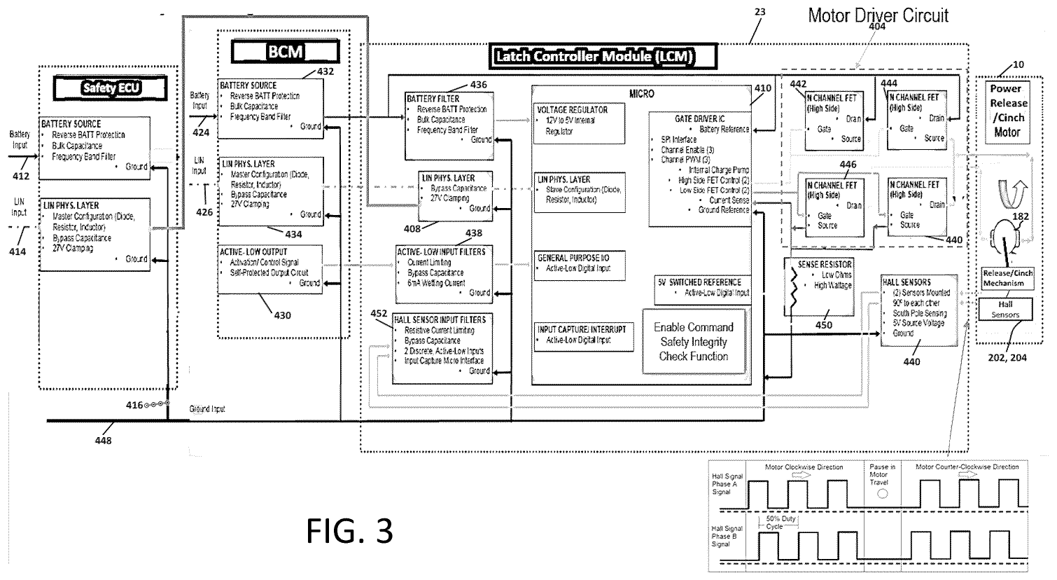

FIG. 3 is a more detailed block diagram showing further details of the actuation system 22. The safety controller 402 includes a safety battery input 412 coupled to the main vehicle battery 405, a safety local interconnect network input 414, and a safety ground input 416 coupled to a main electrical ground 418. The safety controller 402 includes a safety battery source unit 420 connected to the safety battery input 412 and the safety ground input 416. The safety controller 402 also includes a safety local interconnect network physical layer unit 422 connected to the safety ground input 416 and the actuator communication interface unit 408 and the safety local interconnect network input 414 for communicating with the remote controller 25.

The body control module 21 includes a body battery input 424 coupled to the main vehicle battery 405, a body local interconnect network input 426, and a body ground input 428 coupled to the main electrical ground 418. The body control module 21 also includes an active low output unit 430 connected to the body ground input 428 and to the actuator control module 23. The body control module 21 additionally includes a body battery source unit 432 connected to the body battery input 424 and the body ground input 428. Additionally, the body control module 21 includes a body local interconnect network physical layer unit 434 connected body ground input 428 and to the actuator communication interface unit 408 and the body local interconnect network input 426 for communicating with the remote controller 25.

The actuator control module 23 includes an actuator battery filter unit 436 coupled to the main vehicle battery 405 and to the actuator computing unit 410 and to the main electrical ground 418. The actuator control module 23 additionally includes an active low input filter unit 438 coupled to the active low output unit of the body control module 21 and to the actuator computing unit 410 and to the main electrical ground 418. The actuator control module 23 also includes a sensor input unit 440 for coupling to a plurality of actuator sensors 202, 204 of the actuator 320, 321 and coupled to the main electrical ground 418. The motor driver circuit 404 of the actuator control module 23 includes a plurality of motor switches 442, 444, 446, 448 coupled to the main vehicle battery 405 and the actuator computing unit 410 and the motor 182, 322 of the at least one actuator 320, 321. In addition, the actuator control module 23 includes a sense resistor unit 450 coupled to the main electrical ground 418 and the actuator computing unit 410. The actuator control module 23 includes a sensor filter unit 452 coupled to the sensor input unit 440 for filtering signals from the plurality of actuator sensors 202, 204.

Still referring to FIG. 3, the motor of the at least one actuator 320, 321 is shown as a cinch motor 182 of the latch 10. The plurality of actuator sensors 202, 204 include a first cinch sensor 202 and a second cinch sensor 204 disposed ninety degrees out of phase with one another to provide the actuator control module 23 with signals indicative of the rotated position of the cinch gear 188. The actuator computing unit 410 is configured to determine a motor direction of the cinch motor 182 by a rising edge sequence of the first cinch sensor 202 and the second cinch sensor 204 and monitor a duty cycle of a sensor period for sensor continuity and robustness. It should be appreciated that while such sensors 202, 204 are illustrated as being used along with the cinch function of latch 10, other sensors and actuator functions are contemplated.

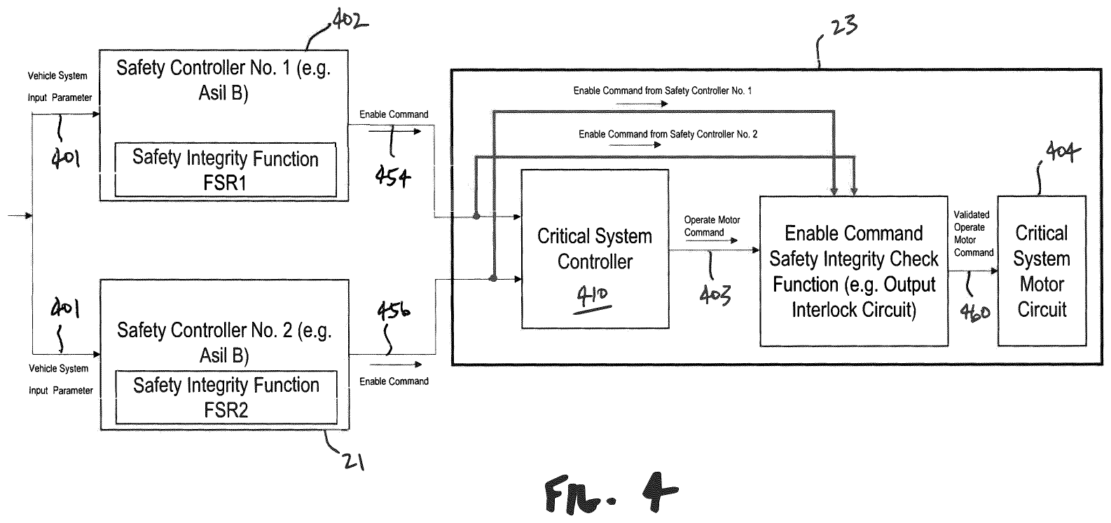

As best shown in FIG. 4, the safety controller 402 is configured to receive the command signal 401 from the remote controller 25 and output a first enable command 454. Similarly, the body control module 21 is configured to receive the command signal 401 from the remote controller 25 and output a second enable command 456. The actuator control module 23 is configured to receive the first enable command 454 and the second enable command 456 and generate the motor control signal 403 based on the first enable command 454 and the second enable command 456. The actuator control module 23 is also configured to perform an enable command safety integrity check of the motor control signal 403 with the first enable command 454 and the second enable command 456 using an output interlock circuit 458. The actuator control module 23 is additionally configured to output a validated motor control signal 460 to the motor driver circuit 404. While the output interlock circuit 458 is shown as part of the actuator control module 23, it should be understood that the output interlock circuit 458 could be separate from the actuator control module 23.

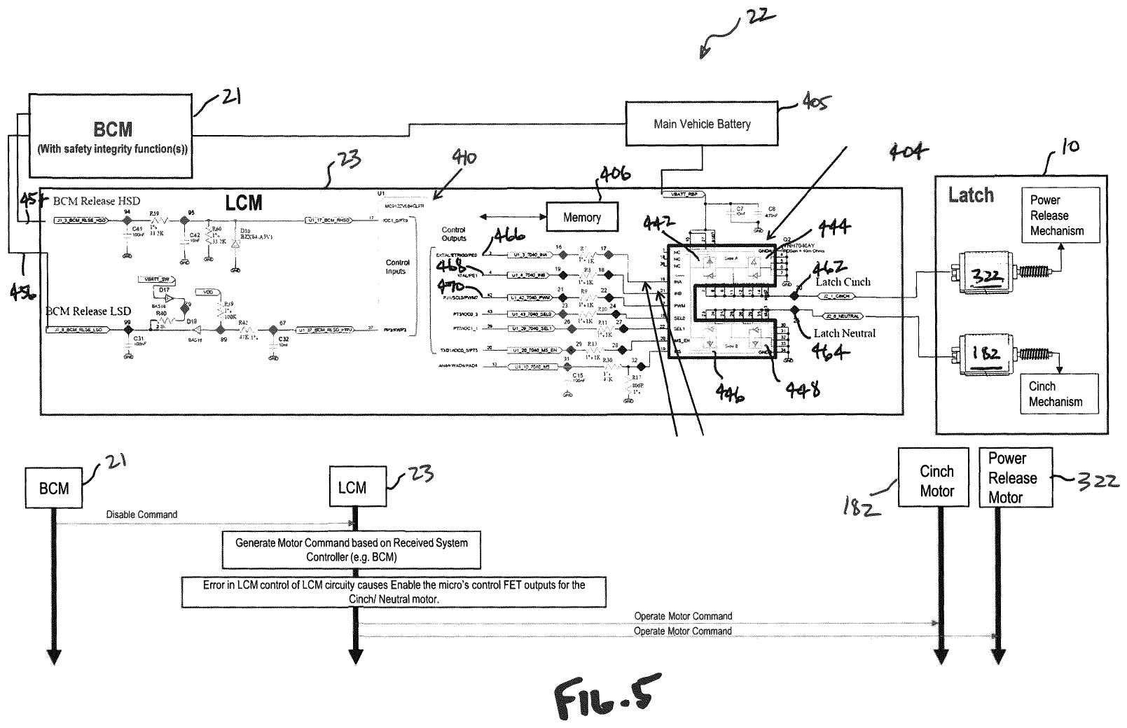

According to an aspect, and as best shown in FIGS. 5-8, the system 22 may not include a motor safety override control function. In other words a fault internal to the actuator control module 23 could cause actuation of the at least one actuator 320, 321 (e.g., latch release). As shown, safety integrity functions are resident in the body control module 21 and the body control module 21 outputs both the first enable command 454 and the second enable command 456. As mentioned above, the motor driver circuit 404 includes a plurality of motor switches 442, 444, 446, 448 coupled to the main vehicle battery 405 and the actuator computing unit 410 and the motor 182, 322. The plurality of motor switches 442, 444, 446, 448 includes a first high side switch 442 and a second high side switch 444 and a first low side switch 446 and a second low side switch 448. The motor driver circuit 404 includes a first motor output 462 coupled to the first high side switch 442 and the second high side switch 444 and to the motor 322 and a second motor output 464 coupled to the first low side switch 446 and the second low side switch 448 and to the motor 182.

The motor driver circuit 404 includes a first primary control line input INA coupled to a first primary control output 466 of the actuator computing unit 410 and a second primary control line input INB coupled to a second primary control output 468 of the actuator computing unit 410 for switching the main vehicle battery 405 to the first motor output 462 and the second motor output 464 based on a first primary control signal and a second primary control signal from the first primary control output 466 and the second primary control output 468 of the actuator computing unit 410. The motor driver circuit 404 also includes a first high side switch input HSA coupled to the first high side switch 442 and a second high side switch input HSB coupled to the second high side switch 444 and a first low side switch input LSA coupled to the first low side switch 446 and a second low side switch input LSB coupled to the second low side switch 448. In addition, the motor driver circuit 404 includes a secondary control line input PWM coupled to a secondary control output 470 of the actuator computing unit 410 for receiving a pulse width modulation (PWM) signal from the secondary control output 470 of the actuator computing unit 410. The secondary control line input PWM increases redundancy to further enhance ASIL D safety for redundant control of inputs that switch ground to the outputs 462, 464 for the motor 182, 322 of the latch 10.

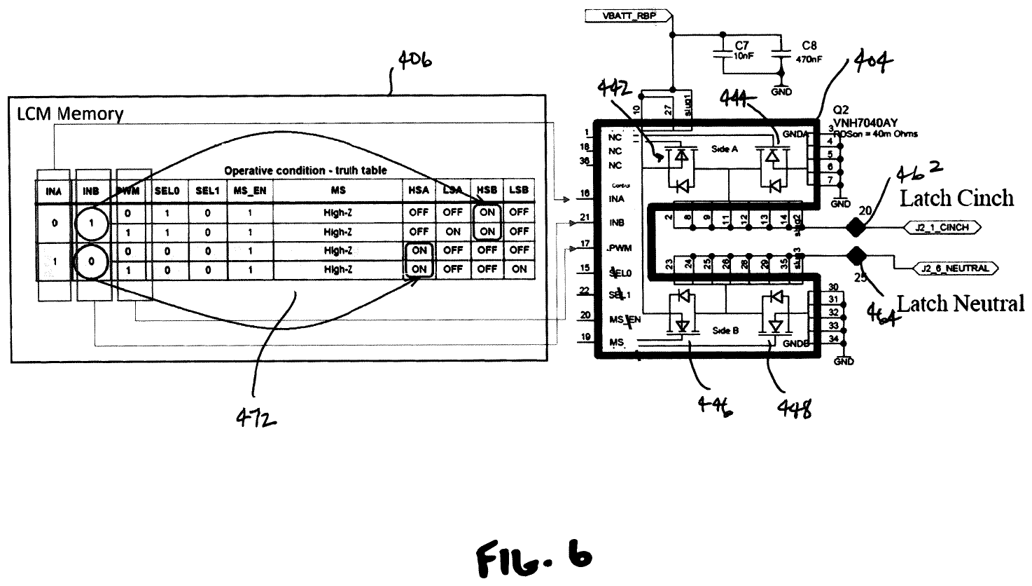

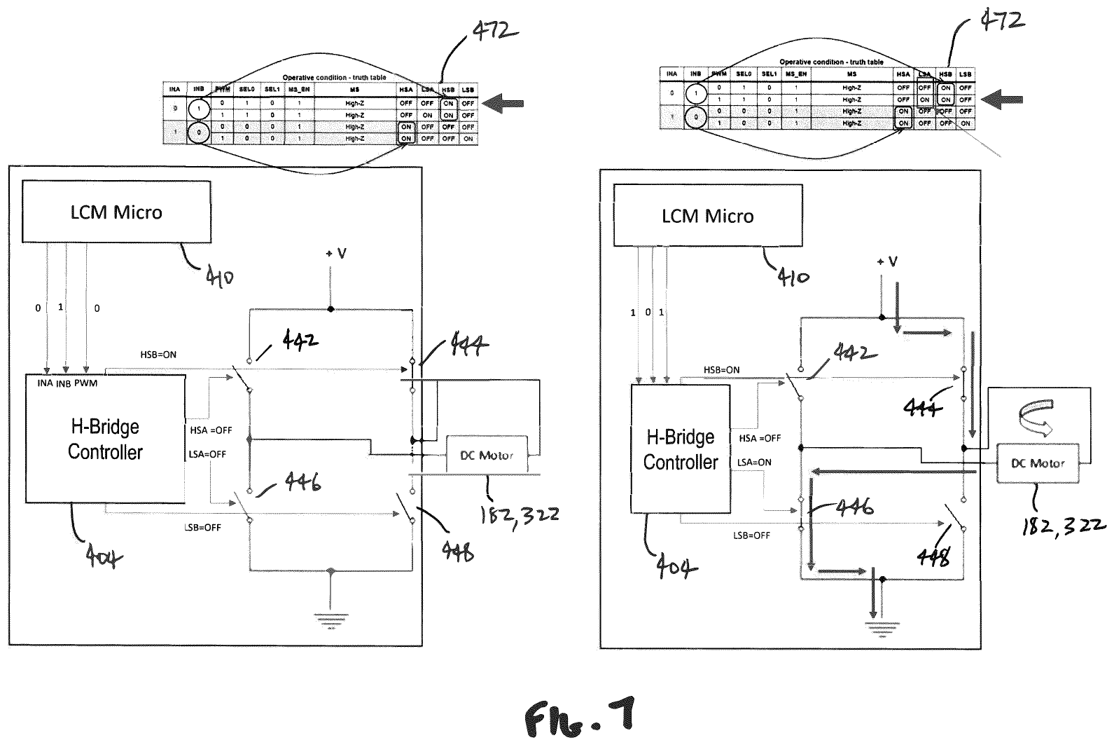

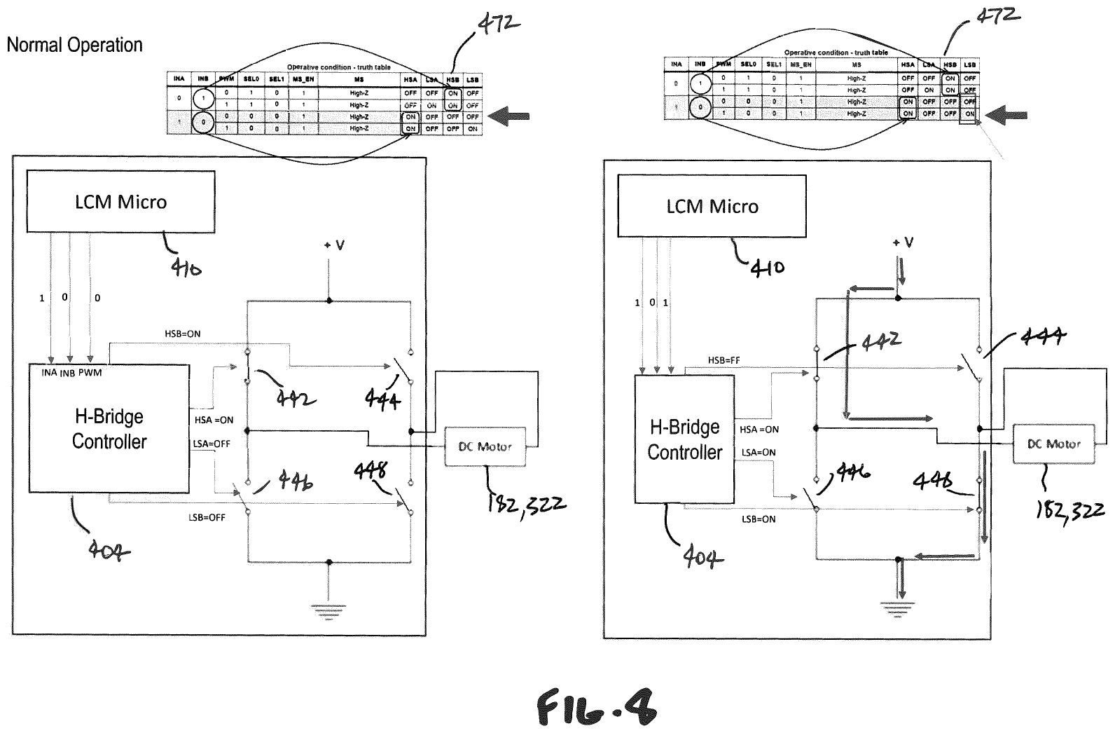

The memory unit 406 includes an operative condition truth table 472 (see FIG. 6) defining and associating a plurality of input entries corresponding to the first primary control line input INA and the second primary control line input INB and the secondary control line input PWM with the first high side switch input HSA and the second high side switch input HSB and the first low side switch input LSA and the second low side switch input LSB. The actuator computing unit 410 is configured to read the operative condition truth table 472 and operate the motor driver circuit 404 accordingly. FIGS. 7 and 8 illustrate operation of the plurality of motor switches 442, 444, 446, 448 based on the operative condition truth table 472. As shown in FIG. 7, for example, the second primary control line input INB being 1 corresponds to the second high side switch input HSB being on (closing the second high side switch 444) while the remaining switches 444, 446, 448 remain off unless the secondary control line input PWM becomes 1, which causes the first low side switch input LSA to be turned on (closing the first low side switch 446).

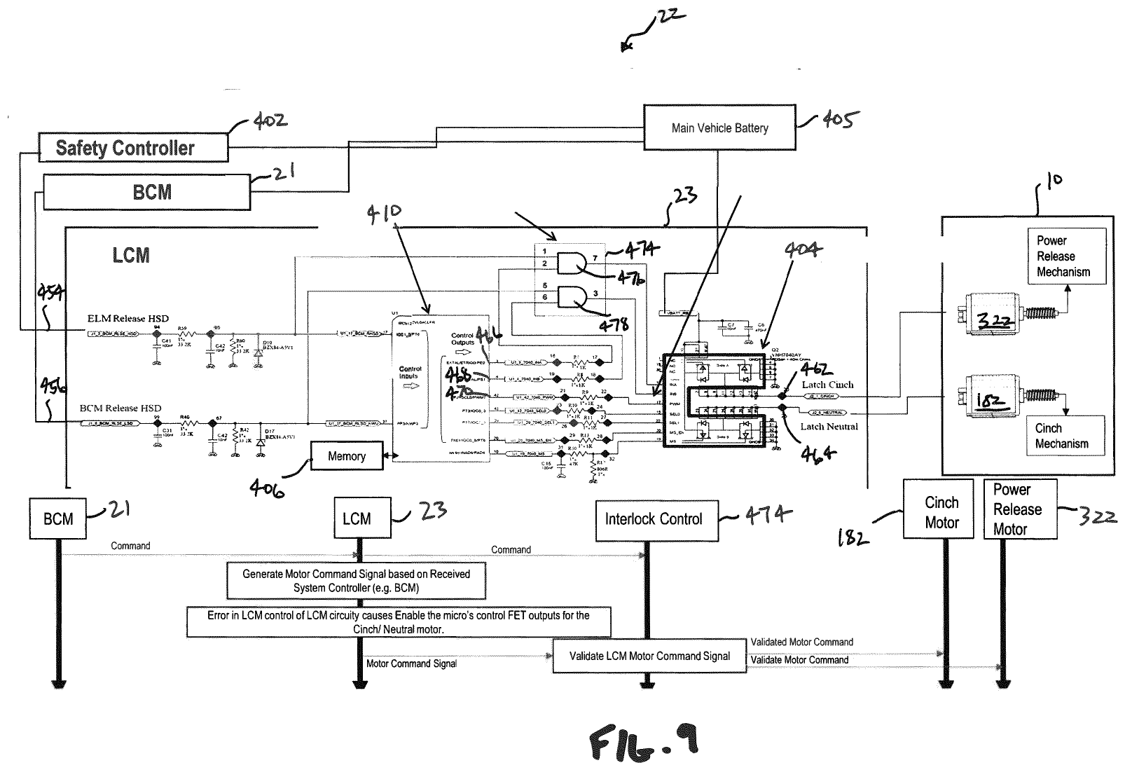

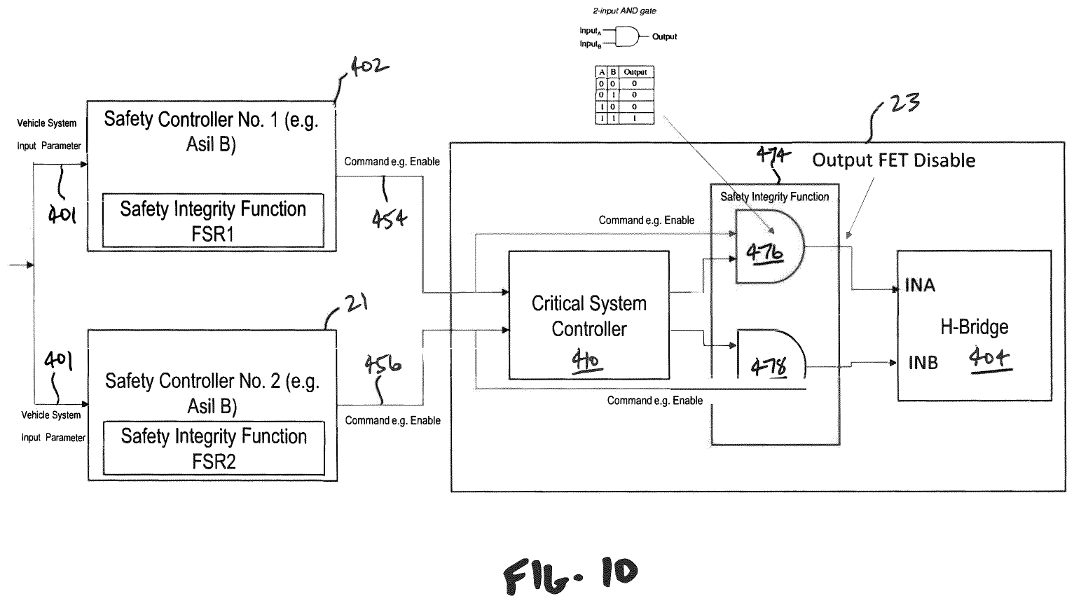

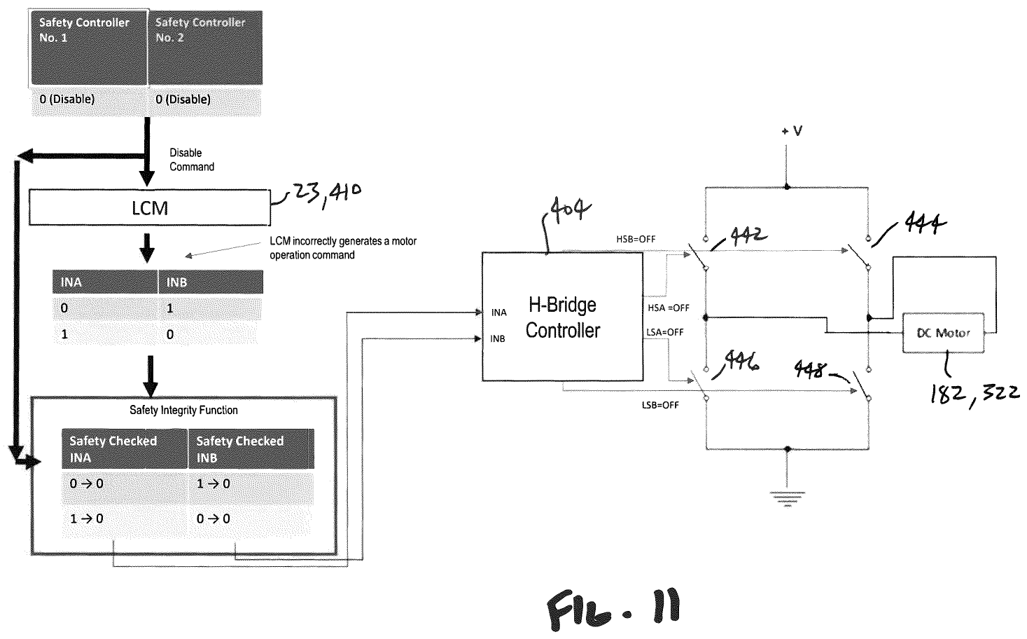

Referring to FIGS. 9-11 and as previously discussed, the at least one actuator controller 21, 23, 402 can include the safety controller 402 coupled to the actuator computing unit 410. As in FIG. 2, the safety controller 402 is configured to receive the command signal 401 from the remote controller 25 and output the first enable command 454. The body control module 21 again is configured to receive the command signal 401 from the remote controller 25 and output the second enable command 456. However, in contrast to the arrangement shown in FIGS. 5-8, the system 22 further includes a primary interlock control unit 474 (e.g., part of the output interlock circuit 458) having a first and logic gate 476 configured to logically and the first enable command 454 and the first primary control signal (e.g., from the first primary control output 466 of the actuator computing unit 410) and output a validated first primary control signal to the first primary control line input INA of the motor driver circuit 404. The primary interlock control unit 474 also includes a second and logic gate 478 configured to logically and the second enable command 456 and the second primary control signal (e.g., from the second primary control output 468 of the actuator computing unit 410) and output a validated second primary control signal to the second primary control line input INB of the motor driver circuit 404. The primary interlock control unit 474 provides safety control of the motor 182, 322 of the latch 10 by using the enable inputs from ASIL B controllers (e.g., ELM and BCM 21). Thus, a motor override function is provided. Specifically, the output of the plurality of motor switches 442, 444, 446, 448 (e.g., FETs) is disabled through an override of the first primary control line input INA and the second primary control line input INB. FIGS. 10 and 11 illustrate operation of this primary override.

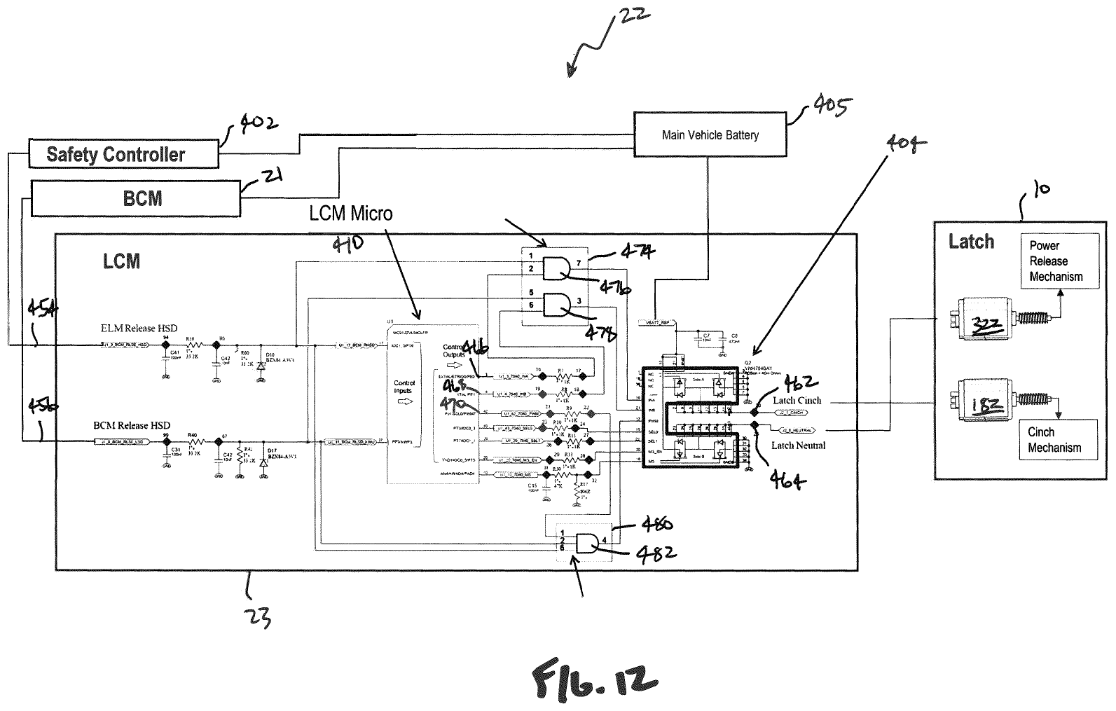

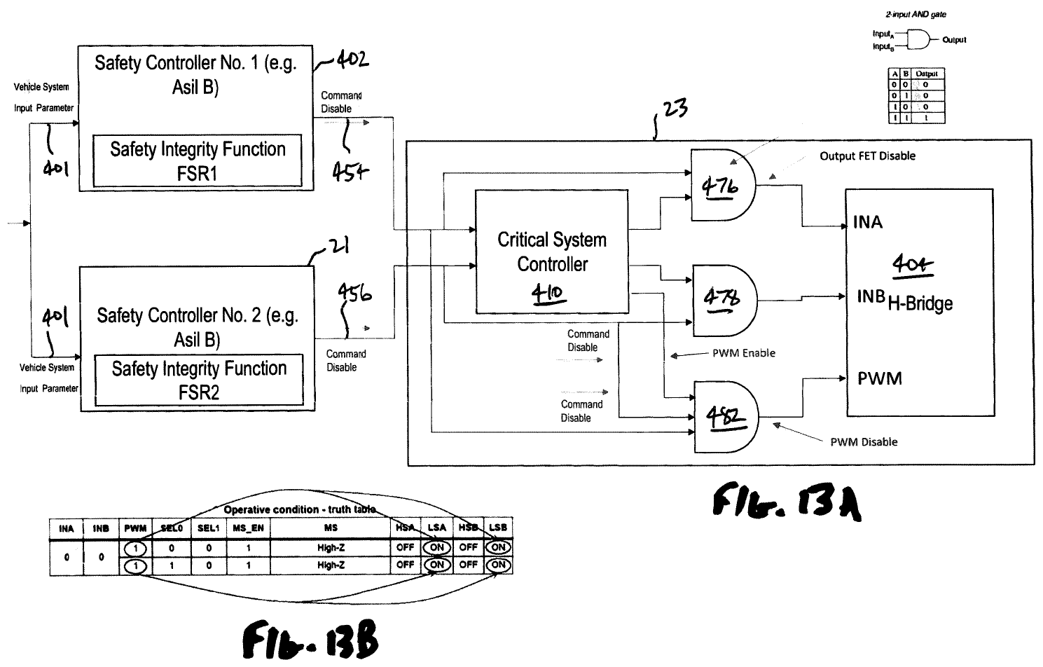

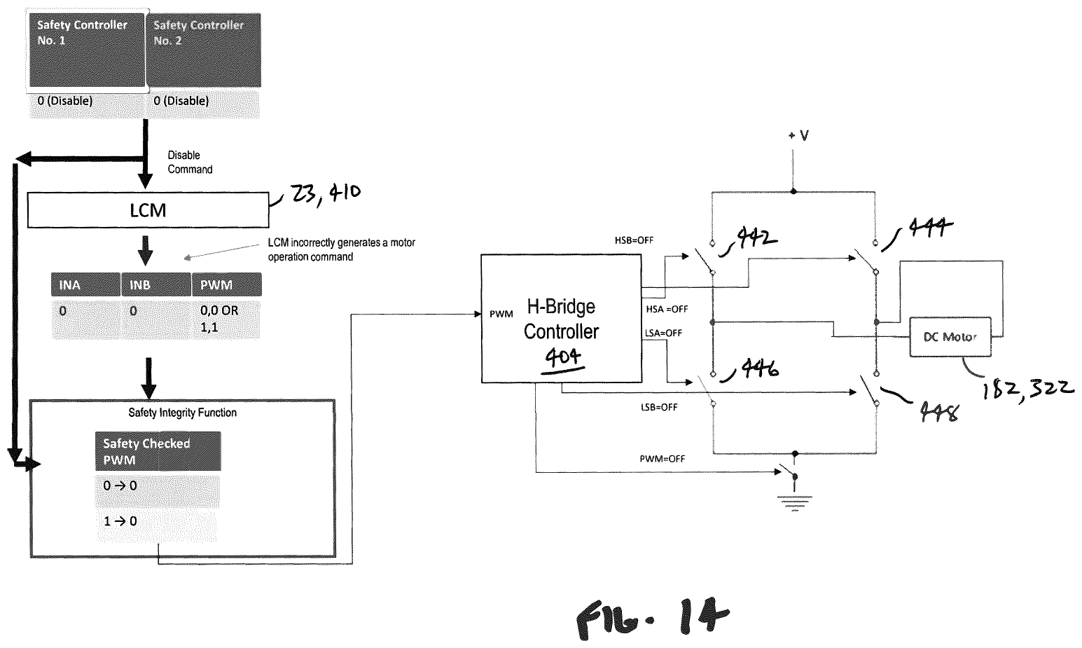

According to another aspect and as best shown in FIGS. 12, 13A-13B, and 14, the system 22 can further include a secondary interlock control unit 480 (e.g., part of the output interlock circuit 458) including a secondary logic and gate 482 configured to logically and the pulse width modulation signal from the secondary control output 470 of the actuator computing unit 410 and the first enable command 454 and the second enable command 456 to output a validated secondary control signal to the secondary control line input PWM of the motor driver circuit 404. Thus, the output of the plurality of motor switches 442, 444, 446, 448 (FETs) is not only disabled through an override of the first primary control line input INA and the second primary control line input INB, but the secondary control line input PWM is also overridden. So, the secondary interlock control unit 480 provides ASIL D safety control of the motor 182, 322 of the latch 10 with full disable of the outputs 462, 464 for the motor 182, 322. FIGS. 13A-13B and 14 illustrate operation of this secondary override.

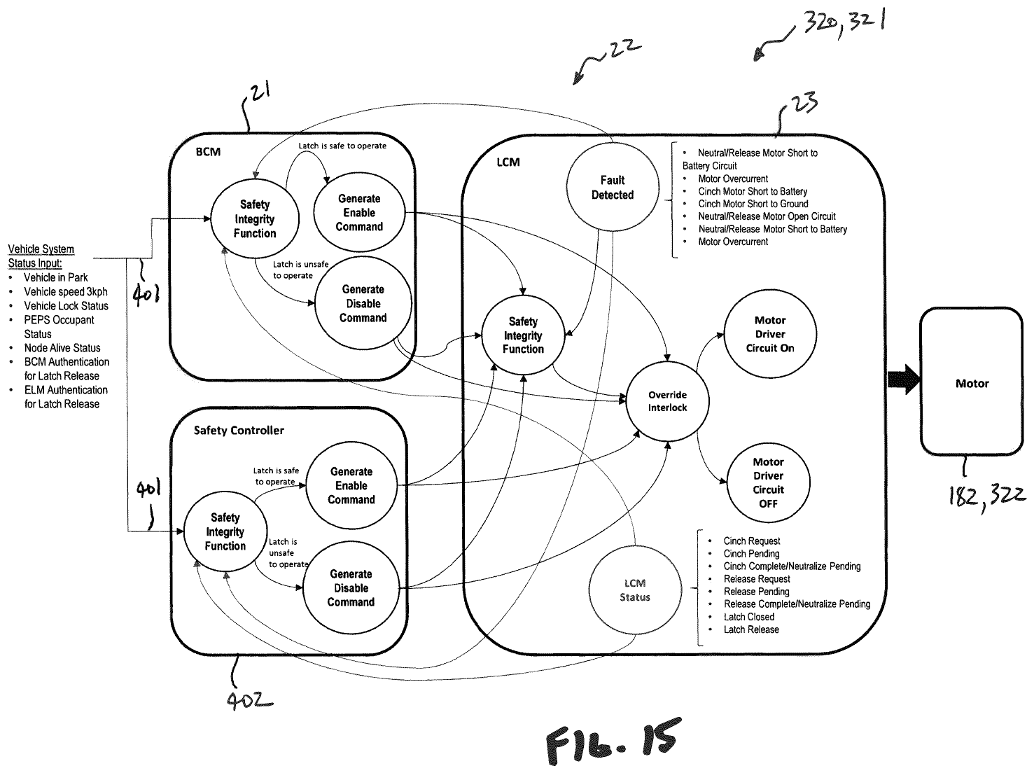

FIG. 15 illustrates a functional diagram of the actuation system 22. As previously discussed, the system 22 includes at least one actuator 320, 321 including a motor 182, 322. Again, a remote controller 25 is configured to generate a command signal 401 to operate the actuator 320, 321. The at least one local controller 21, 23, 402 can integrated in the at least one actuator 320, 321 and can be in communication with the remote controller 25 and the at least one actuator 320, 321. The at least one local controller 21, 23, 402 is configured to receive the command signal 401 from the remote controller 25 to operate the actuator 320, 321 and determine the state of the actuator 320, 321. The at least one local controller 21, 23, 402 also determines a fault of the actuator 320, 321 and generates a motor control signal 403 using at least one of the command signal 401, the state of the at least one actuator 320, 321, and the fault of the at least one actuator 320, 321 for actuating the motor 182, 322 to operate the at least one actuator 320, 321. The at least one local controller 21, 23, 402 additionally transmits the at least one of the fault and the state of the at least one actuator 320, 321 to the remote controller 25.

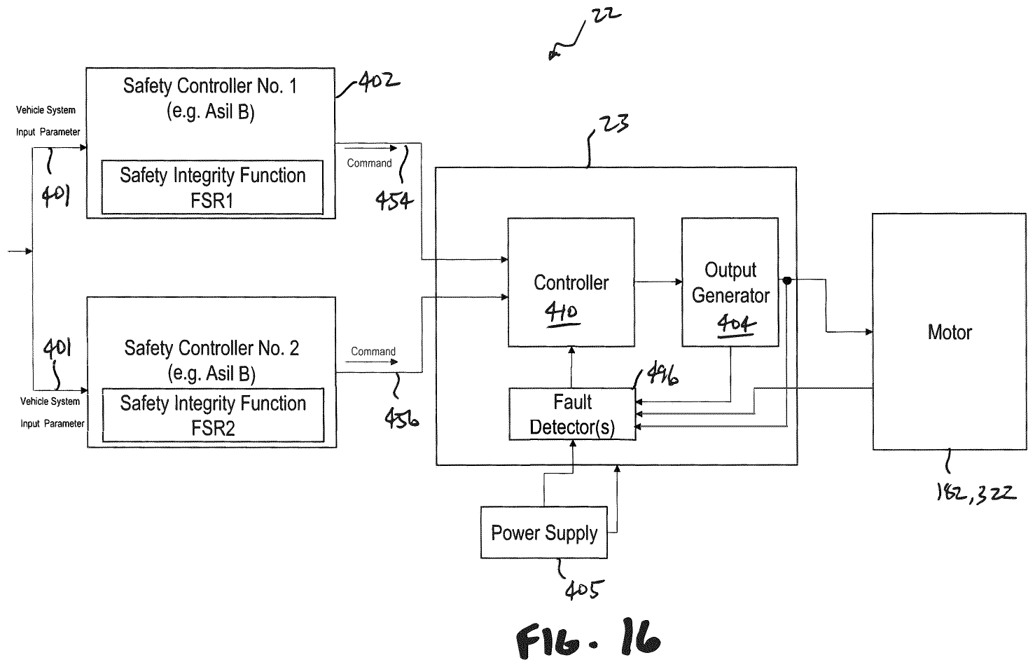

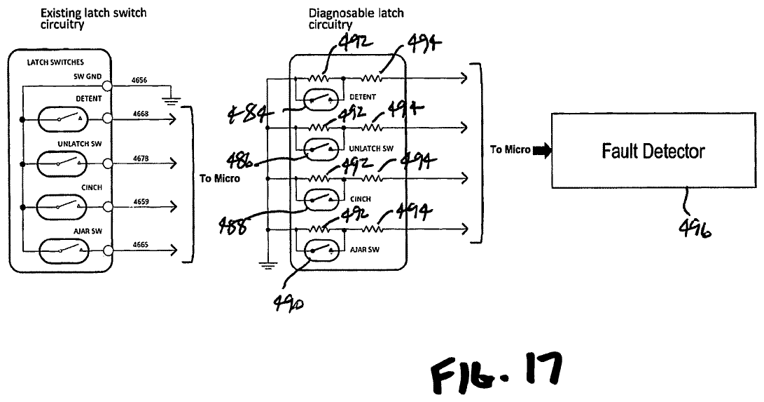

As best shown in FIGS. 16 and 17, the at least one actuator 320, 321 of the actuation system 22 further includes a plurality of actuator switches 484, 486, 488, 490 indicative of the state of the at least one actuator 320, 321. Each of the plurality of actuator switches 484, 486, 488, 490 includes a parallel resistor 492 connected in parallel with each of the plurality of actuator switches 484, 486, 488, 490 and a series resistor 494 connected in series with each of the plurality of actuator switches 484, 486, 488, 490 for allowing diagnosis of each of the plurality of actuator switches 484, 486, 488, 490. The at least one local controller 21, 23, 402 also includes at least one fault detector 496 configured to diagnose the plurality of actuator switches 484, 486, 488, 490. More specifically, the plurality of actuator switches 484, 486, 488, 490 includes at least one of a detent switch 484 and an unlatch switch 486 and a cinch switch 488 and an ajar switch 490. So, the ASIL D configuration of inputs includes the ability to diagnose the control inputs to the at least one fault detector 496 for open circuit, short to battery, short to ground, or out of range.

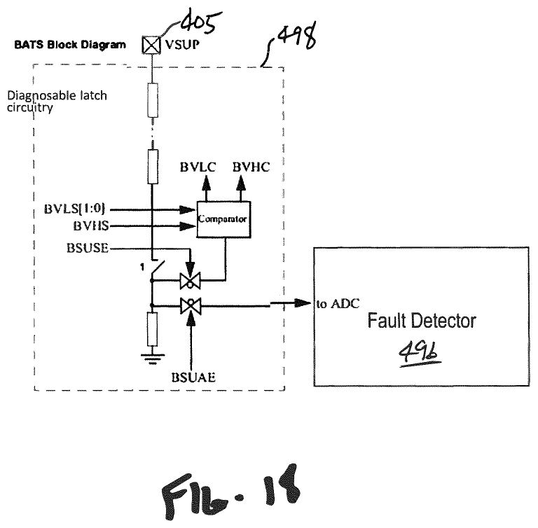

Referring to FIG. 18, the actuation system 22 can further include a battery voltage fault detector circuit 498 (BATS), as shown, coupled to a main vehicle battery 405 for detecting a battery voltage of the main vehicle battery 405 (VSUP). An internal ADC interface from an internal resistive divider is provided. The battery voltage fault detector circuit 498 is coupled to the at least one fault detector 496 to determine whether the battery voltage is out of a predetermined range and generate an interrupt (e.g., high or low voltage interrupts) accordingly.

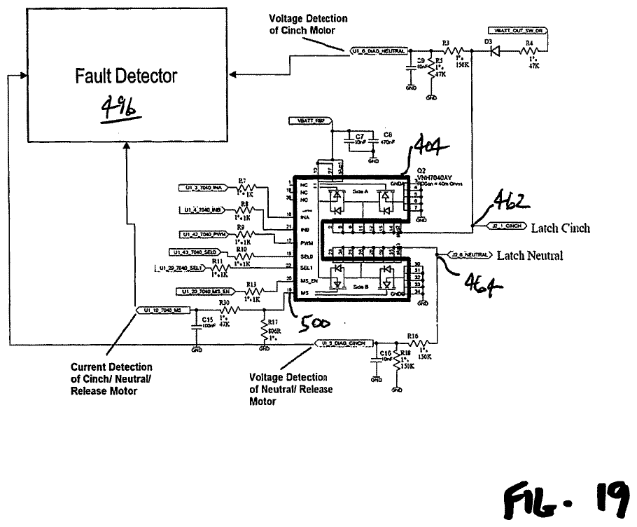

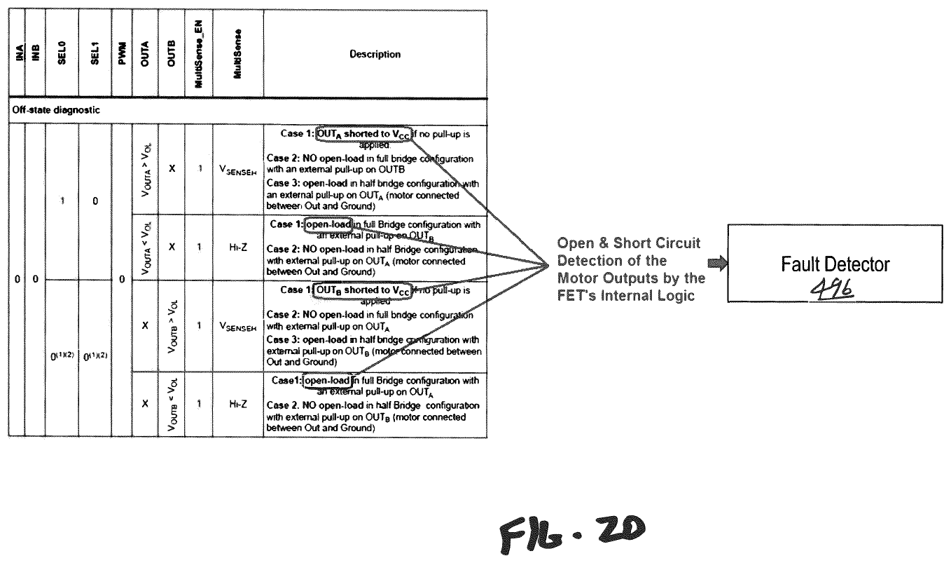

As best shown in FIG. 19, the motor drive circuit 404 of the at least one local controller 21, 23, 402 has a current level output 500 coupled to the at least one fault detector 496 for sensing a current of the first motor output 462 and the second motor output 464. As mentioned, the motor driver circuit 404 includes the first motor output 462 coupled to the motor 182, 322 and a second motor output 464 coupled to the motor 182, 322 and each of the first motor output 462 and the second motor output 464 are coupled to the at least one fault detector 496 for sensing a voltage of the first motor output 462 and the second motor output 464. So, the LCM 23 incorporates voltage and current detection of the motor outputs 462, 464 (internal to the FET integrated circuit). The voltage circuits are monitored before, during, and after operations of the motor 182, 322. The current detection is monitored during operation of the motor 182, 322 for current within and outside of an operational range. FIG. 20 illustrates example diagnostics of the plurality of motor switches 442, 444, 446, 448 for open circuit and short circuit detection of the first motor output 462 and the second motor output 464.

A method for controlling the actuator 320, 321 including the motor 182, 322 is also provided. The method includes the step of receiving a command signal 401 from a remote controller 25 to operate the actuator 320, 321. Next, generating a motor control signal using the command signal 401 for actuating the motor 182, 322 to operate the at least one actuator 320, 321. The method continues by comparing the motor control signal and the command signal 401 to determine the validity of the motor control signal. The method also includes the step of preventing actuation of the motor 182, 322 if the motor control signal is invalid.

The method may further include the step of defining and associating a plurality of input entries in an operative condition truth table 472 corresponding to a first primary control line input INA and a second primary control line input INB and a secondary control line input PWM with a first high side switch input HSA and a second high side switch input HSB and a first low side switch input LSA and a second low side switch input LSB of a motor drive circuit 404 coupled to the motor 182, 322. Again, the memory unit 406 can include the operative condition truth table 472. The method proceeds with the step of reading the operative condition truth table 472 and operating the motor driver circuit 404 accordingly.

The method can additionally include the steps of receiving the command signal 401 from the remote controller 25 and outputting the first enable command 454 using a safety controller 402 and receiving the command signal 401 from the remote controller 25 and outputting the second enable command 456 using a body control module 21. The method can continue with the step of receiving the first enable command 454 and the second enable command 456 and generating the motor control signal 403 based on the first enable command 454 and the second enable command 456 using an actuator control module 23. Next, performing an enable command safety integrity check of the motor control signal 403 with the first enable command 454 and the second enable command 456 using the latch control module 23 and outputting a validated motor control signal 460 to the motor driver circuit 404.

In addition, the method can further include the step of logically anding the first enable command 454 and a first primary control signal from an actuator computing unit 410 and outputting a validated first primary control signal to the first primary control line input INA of the motor driver circuit 404 using a first and logic gate 476 of a primary interlock control unit 474. The method also includes logically anding the second enable command 456 and a second primary control signal from the actuator computing unit 410 and outputting a validated second primary control signal to the second primary control line input INB of the motor driver circuit 404 using a second and logic gate 478 of the primary interlock control unit 474. The method can also include the step of logically anding a pulse width modulation signal from the actuator computing unit 410 and the first enable command 454 and the second enable command 456 to output a validated secondary control signal to a secondary control line input PWM of the motor driver circuit 404 using including a secondary logic and gate 482 of a secondary interlock control unit 480.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A safety critical system for controlling a vehicle component, comprising:
a safety controller configured to issue a safety command signal representative of a safety critical decision based on a safety-related function;
an actuator controller configured to receive the safety command signal and generate a motor actuation command signal using the safety command signal, and further configured to generate a validated motor actuation command signal using the motor actuation command signal and the safety command signal; and
an actuator comprising a motor configured to control the vehicle component in response to receiving the validated motor actuation command signal.

2. The safety critical system as set forth in claim 1, the actuator controller further configured to receive another safety command signal, generate the motor actuation command signal using the safety command signal and the another safety command signal, and generate the validated motor actuation command signal using the motor actuation command signal and at least one of the safety command signal and the another safety command signal.

3. The safety critical system as set forth in claim 2, further comprising a second safety controller configured to issue the another safety command signal.

4. The safety critical system as set forth in claim 2, wherein the actuator controller is configured to generate the validated motor actuation command signal in response to determining a discrepancy between the motor actuation command signal and at least one of the safety command signal and the another safety command signal.

5. The safety critical system as set forth in claim 4, wherein the actuator controller further includes a safety module configured to receive the motor actuation command signal and at least one of the safety command signal and the another safety command signal, to determine the discrepancy, to generate the validated motor actuation command signal using the motor actuation command signal and at least one of the safety command signal and the another safety command signal, and to supply the actuator with the validated motor actuation command signal.

6. The safety critical system as set forth in claim 5, wherein the motor actuation command signal comprises at least one of a motor high side drive signal for controlling a high side drive circuit coupled to the actuator, and a motor low side drive signal for controlling a low side drive circuit coupled to the actuator.

7. The safety critical system as set forth in claim 6, wherein the safety module is configured to not modify the at least one of the motor high side drive signal and the motor low side drive signal in response to not determining a discrepancy between the motor actuation command signal and the at least one of the safety command signal and the another safety command signal, and to modify the at least one of the motor high side drive signal and the motor low side drive signal in response to determining the discrepancy between the motor actuation command signal and at least one of the safety command signal and the another safety command signal.

8. The safety critical system as set forth in claim 7, wherein in response to determining the discrepancy between the motor actuation command signal and at least one of the safety command signal and the another safety command signal, the modified at least one of the motor high side drive signal and the motor low side drive signal causes disablement to operation of the actuator.

9. The safety critical system as set forth in claim 8, wherein the modified at least one of the motor high side drive signal and the motor low side drive signal controls at least one switch to prevent a voltage from being applied across terminals of the motor to cause disablement to operation of the actuator.

10. The safety critical system as set forth in claim 9, wherein the at least one switch forms part of an H-Bridge circuit comprising a low side drive circuit and a high side drive circuit coupled to the motor and configured to control application of a voltage differential to the motor based on a state of the at least one switch.

11. The safety critical system as set forth in claim 10, wherein the safety module is configured to output a safety command signal consisting of at least one of a high side command signal for controlling the high side drive circuit and a low side command signal for controlling the low side drive circuit, the safety module comprising at least one of a first logical gate comprising a first input configured to receive the high side command signal and a second input configured to receive the motor high side drive signal, and an output coupled to the high side drive circuit, and a second logical gate comprising a first input configured to receive the low side command signal and a second input configured to receive the motor low side drive signal, and an output coupled to the low side drive circuit.

12. The safety critical system as set forth in claim 11, wherein the first logical gate and the second logical gate are each AND gates, and the discrepancy is a logical output of the AND gate.

13. The safety critical system as set forth in claim 1, wherein the safety controller comprises a first safety controller and a second safety controller independent from the first safety controller each configured to receive a control input from a vehicle system.

14. The safety critical system as set forth in claim 13, wherein one of the first safety controller and the second safety controller are each configured to generate one of a low side command signal using the control input and a safety integrity function, and the other one of the first safety controller and the second safety controller is configured to generate a high side command signal using the control input and another safety integrity function.

15. The safety critical system as set forth in claim 13, wherein one of the first safety controller and the second safety controller is a Body Control Module.

16. The safety critical system as set forth in claim 13, wherein the vehicle component is a frunk, the control input is a power release command, and the vehicle system is a user activated device provided within a cabin of a vehicle.

17. The safety critical system as set forth in claim 1, wherein the actuator controller is a Latch Control Module, and the actuator is configured to control at least one of a power release operation, a cinch operation, or a lock/unlock operation of a latch.

18. The safety critical system as set forth in claim 1, wherein the vehicle component is a frunk.

19. The safety critical system as set forth in claim 1, wherein the safety controller is a Body Control Module.

20. An ASIL D compliant latch control module having a safety module having a output interlock circuit for receiving a safety signal from a safety controller having a lower than an ASIL D safety compliance level as substantially shown and described.
